(19) United States
(12) Patent Application Publication
(10) Pub. No.: US 2008/0044577 A1
(43) Pub. Date: Feb. 21, 2008

(54) Antifouling coating for fresh-water containment

(76) Inventor: Vernon Harland Batdorf, Minneapolis, MN (US)

Correspondence Address: Vernon H. Batdorf, 5014 41St Ave So., Minneapolis, MN, 55417, US

(21) Appl. No.: 11/506,643

(22) Filed: Aug. 18, 2006

(51) Int. Cl. B05D 3/02

(52) U.S. Cl. 427/384

(57) ABSTRACT

A method for the preparation of antifouling coatings wherein aqueous compositions are applied onto a surface and when dried, effectively inhibit algae growth and other plant growth for an extended period of time when submerged in fresh-water and subject to ambient environmental conditions.

### INTRODUCTION

The invention relates to an antifouling composition. Specifically, it relates to a method for the manufacture of a coated surface having antifouling characteristics. More specifically, it relates to a coated substrate having effective antifouling characteristics including hydrophobicity, abrasion resistance, fungal growth inhibition, algae growth inhibition, and many aqueous plants growth inhibition. The antifouling coating is particularly useful on surfaces that are continuously exposed to fresh-water.

### BACKGROUND OF THE INVENTION

It is generally known that antifouling coatings are useful on surfaces that are continuously exposed to water. Patent examples include the following:

U.S. Pat. No. 7,087,106 (Kem, et al.) disclose materials and methods for inhibiting the biofouling of surfaces exposed to aquatic environments. In one embodiment, the subject invention provides additives for marine paints and surface treatments. The subject invention further provides repellants and selective inhibitors for aquatic and/or terrestrial crustacean pests.

U.S. Pat. No. 6,916,860 (Oya, et al.) disclose an antifouling solvent based coating composition, coating film therefrom, base material covered with the coating film and antifouling method.

Although the exemplary patents described above provide effective antifouling coatings, there is a particular need for an efficient and cost effective antifouling water based coating for use in irrigation canals that supply fresh-water to farmers to irrigate their crops. Growth of algae, moss, pond weed and other plants create cracks in the walls which result in fresh-water loss as high as 50 percent of the flow. The plant growth also creates a turbulent flow condition which slows up the fresh-water flow, resulting in less fresh-water for the farmers. In the State of Washington one district has an annual maintenance cost of 12-14 million dollars in controlling the growth, and making repairs to the canals. The current method of controlling the plant and micro-organisms is to use a chemical in the fresh-water, which now is being restricted by the Environmental Protection Agency (EPA). One alternate method being promoted to control the growth and prevent fresh-water loss through cracks in the walls is to apply a rubber barrier membrane to the canal concrete walls and bottom. Currently, the rubber barrier membrane technology is cost prohibiting given the large amount of surface area requiring protection.

Furthermore, algae growth remains a problem in swimming pools often requiring annual draining and cleaning of the pool surfaces, especially in the southern United States. The algae grows back soon after cleaning making for an unsightly pool.

There remains a need for antifouling coatings, useful in retaining structures for fresh-water, having an effective combination of properties including low fresh-water extractable, abrasion resistance, ultra-violet (UV) resistance, and growth inhibition.

### SUMMARY OF THE INVENTION

The method provides antifouling coated surfaces, useful for retaining structures for fresh-water, having effective long term durability and resistance to algae growth, moss growth, pondweed growth and other aqueous plant growth. Specifically, the method provides coated surfaces having an effective combination of properties including a fresh-water extractable content less than about 8 percent, and an abrasion resistance of less than about 0.40 grams loss using the falling sand method.

The coating method comprising the steps of:
1) providing at least one antifouling composition comprising;
   i) at least one aqueous polymer;
   ii) at least one algaecide;
   iii) at least one fungicide;
   iv) at least one UV absorbing component
   v) at least one surfactant
2) providing at least one retaining structure for fresh-water;
3) applying said composition onto said structure to form a wet-coated substrate; then
4) drying the wet-coated substrate to provide dried antifouling coating.

Surprisingly, the aqueous composition can be applied onto a surface at less than about 800 square-feet per gallon and when dried, effectively inhibits algae and other aqueous plant growth thereon for greater than about 130-days wherein the dried antifouling coating is continuously submerged in fresh-water and subject to ambient environmental conditions.

### DETAILED DESCRIPTION OF THE INVENTION

The term “fresh-water” as used herein is defined as water having a salinity of less than about 0.5 parts per thousand dissolved salts.

The term “sea water” as used herein is defined as water having a salinity in a range of from about 3 percent to about 4 percent and a density in a range of from about 1020 kg·m⁻³ to about 1030 kg·m⁻³.

The present invention discloses a method for the preparation of coated surfaces, having effective antifouling characteristics, comprising the steps of:
1) providing at least one aqueous composition comprising;
   a. at least one aqueous polymer;
   b. at least one algaecide;
   c. at least one fungicide;
   d. at least one ultra-violet absorbing component
   e. at least one surfactant
2) providing at least one substrate used as a retaining structure for fresh-water;
3) applying said composition onto said substrate to form a wet-coated substrate;
4) drying the wet-coated substrate.

The method of the present invention is particularly useful for controlling and inhibiting the growth of various aqueous plants and other micro-organisms on the walls and bottom of canals, swimming pools, reservoirs, ponds, water treatment sites, and other non-potable water containing constructions. The aqueous composition used in the method of the invention contains a unique blend of fungicides and algaecides that effectively inhibit the growth of various aqueous plants and are preferably United States Environmental Protection Agency (EPA) approved for use in these types of applications.

Preferably, the antimicrobial has very low fresh-water solubility (less than about 50 parts per million), and being very fine solids that are dispersed within the coating binder. The coating is based upon a hydrophobic binder that has excellent fresh-water resistance, and binds the antimicrobials within the film, allowing a very small amount to migrate to the coating surface as needed.

The aqueous composition used in the method of the present invention comprises at least one aqueous polymer. Useful aqueous polymers include aqueous polyacrylics, aqueous polystyrene-acrylics, aqueous polystyrene-butadiene rubbers, and aqueous polychlorinated-ethylene-acetate copolymers. A preferred aqueous polymer is BASF ND 4606 from BASF, Charlotte, N.C. and Ucar 820 from Dow Chemical, Midland, Mich. The aqueous polymer is present in the antifouling composition in a range of from about 10 percent by weight to about 50 percent by weight, preferably from about 15 percent by weight to about 45 percent by weight based on the total weight of the antifouling composition. Polymer content greater than about 50 percent by weight may be less desirable in that it would be too costly, and not allow for sufficient pigment content. Alternatively, polymers content less than about 10 percent by weight may be less desirable in that it would result in insufficient binder to retain the antimicrobials, have low film thickness, and poor abrasion resistance.

The aqueous composition used in the method of the invention contains at least one algaecide. Useful algaecides include Nuocide 404D, ISP Corp., Charlotte, N.C., Zinc and Sodium Omadine, Arch Chemical, Cheshire, Conn., Amical Flowable, Dow Chemical, Midland, Mich., Rozone 2000, Rozone 200, Rocima 63, Rocima 65 or Skane 8 from Rohm & Haas, Springhouse, Pa., Mergal S-90, Polyphase 588, and Mergal S-89 from Troy Chemical, Florham, N.J., and Irgarol 1071 or 1075 from ISP Corp., Charlotte, N.C. Examples of preferred algaecides include Irgarol 1071 or 1075 from ISP Corp., Charlotte, N.C., and Rocima 63 or 65 from Rohm & Haas, Springhouse, Pa. The algaecide (active content) is present in the antifouling composition in a range of from about 0.10 percent by weight (active) to about 4.0 percent by weight, preferably from about 0.20 percent by weight to about 2.0 percent by weight based on the total weight of the antifouling composition. Algaecide content greater than about 4.0 percent by weight may be less desirable in that excessive cost with diminishing value and excessive leaching into the fresh-water likely. Alternatively, algaecide content less than about 0.10 percent by weight may be less desirable in that it would be insufficient to control all the algae and other aqueous plants, and have a shortened useful life.

The aqueous composition used in the method of the invention contains at least one fungicide. These fungicides have some algaecidal activity by themselves or in combination with the primary algaecide(s). Useful fungicides include Diuron, Dupont Chemical, Wilmington, Mass., Nuocide 404D or 960, ISP Corp., Charlotte, N.C., Zinc and Sodium Omadine, Arch Chemical, Cheshire, Conn., Amical Flowable or 48, Dow Chemical, Midland, Mich., Rozone 2000, Rozone 200, Rocima 63, or Rocima 65 from Rohm & Haas, Springhouse, Pa., Mergal S-89 and S-90, Polyphase AF-1 and Polyphase 588 from Troy Chemical, Florham, N.J., and Metasol TK-50 A.D. from Lanxess Corporation. Examples of preferred fungicides include Nuocide 404D, Mergal S-90, and Zinc or Sodium Omadine. In some cases the addition of Magnesium Hydroxide and Zinc or Barium meta-Borate have been found useful. The fungicide (active content) is present in the aqueous composition in a range of from about 0.10 percent by weight (active) to about 2.0 percent by weight, preferably from about 0.20 percent by weight to about 1.0 percent by weight based on the total weight of the antifouling composition. Fungicide content greater than about percent by weight may be less desirable in that of a high cost, diminishing value, and excessive leaching into the fresh-water likely. Alternatively, algaecide content less than about 0.10 percent by weight may be less desirable in that it would be insufficient to control all the algae and other aqueous plants, and have a shortened useful life.

All the algaecides and fungicides are used at a level within the United States Environmental Protection Agency (EPA) allowed ranges, and at a level as required for long term protection depending upon the degree of exposure. In situations where multiple types or species of organisms are likely to be found, two or more antimicrobial types (algaecides and/or fungicides) may be required in other to inhibit the growth of all of them. Preferably, the antimicrobials have low fresh-water solubility (less than about 50 parts per million), excellent resistance against hydrolysis, be resistant to degradation by UV where exposed to sunlight (unless sufficient UV absorbers are used), and are unaffected by other chemicals that maybe added into the contained fresh-water.

The aqueous composition used in the method of the invention may contain at least one thickener. Useful thickeners include Kelzan S from CP Kelco, Cellosize QP-100 MH or QP-4400 from Dow Chemical, Alcogum L-89 or SL-117 from Alco Chemical, Or Rheolate 244 or 300 from Elementis Specialties. Examples of preferred thickeners include Kelzan S from CP Kelco, and Cellosize QP-100 MH from Dow Chemical. The thickener may be present in the antifouling composition in a range of from about 0.10 percent by weight to about 3.0 percent by weight, preferably from about 0.20 percent by weight to about 1.0 percent by weight based on the total weight of the antifouling composition. The antifouling composition has a viscosity in a range of from about 500 centipoise to about 10,000 centipoise, preferably from about 800 centipoise to about 6000 centipoise. A viscosity greater than about 10,000 centipoise may be less desirable in that it would likely not spray well and have poor wetting out of the substrate and any surface algae growth. Alternatively, a viscosity less than about 500 centipoise may be less desirable in that it would run down on vertical surfaces leaving too thin of a film, and would tend to show separation in the container on standing before it could be applied.

The aqueous composition used in the method of the invention may contain at least one defoamer. Useful defoamers include DFC-17 or 47 from HiMar Specialities, Antifoam B, Additive 62 and 65 from Dow Corning Corp., Rhodialine 646 or 675 from Rhodia, Inc. Examples of preferred defoamers include DFC-17 from HiMar Specialities, and Antifoam B from Dow Corning Corp. The defoamer may be present in the antifouling composition in a range of from about 0.10 percent by weight to about 1.0 percent by weight, preferably from about 0.20 percent by weight to about 0.50 percent by weight based on the total weight of the antifouling composition. Defoamer content greater than about 1.0 percent by weight may be less desirable in that cause film surface defects and loss of adhesion to the substrate. Alternatively, defoamer content less than about 0.10 percent by weight may be less desirable in that it could be insufficient to completely prevent excessive air entrapment.

The aqueous composition used in the method of the invention may contain at least one surfactant. When present in the composition, the surfactant is a means to lower surface tension for improved surface wetting, pigment dispersion and polymer stability. Useful surfactants include Triton X-100 or X-405 from Dow Chemical, Surfynol Tg or Surfynol 104H or Surfynol PSA 336 from Air Products. Examples of preferred surfactants include PSA 336 and Triton X-100 from Dow Chemical. The surfactant may be present in the antifouling composition in a range of from about 0.10 percent by weight to about 2.0 percent by weight, preferably from about 0.20 percent by weight to about 1.0 percent by weight based on the total weight of the antifouling composition. Surfactant content greater than about 2.0 percent by weight may be less desirable in that it would hurt the dried film's fresh-water resistance and durability. Alternatively, a surfactant content less than about 0.10 percent by weight may be less desirable in that it would not sufficiently lower the surface tension for adequate surface wetting and aiding in pigment dispersion.

The aqueous composition used in the method of the invention may contain at least one dispersant. When present in the composition, the dispersant is a means to disperse the pigments and prevent agglomeration on product aging. Useful dispersants include BYK-155, 156, 190, 191, or 194 from BYK Chemie, AMP-95 from Dow Chemical, and Tamol 850 or 730 from Rohm & Haas. Examples of preferred dispersants include AMP-95 from Dow Chemical, and BYK-156 from BYK Chemie. The dispersant may be present in the antifouling composition in a range of from about 0.10 percent by weight to about 3.0 percent by weight, preferably from about 0.20 percent by weight to about 1.0 percent by weight based on the total weight of the antifouling composition. Dispersant content greater than about 3.0 percent by weight may be less desirable in that it could adversely affect viscosity stability and fresh-water resistance of the dried film. Alternatively, a dispersant content less than about 0.10 percent by weight may be less desirable in that the product would show poor viscosity stability on aging, pigment agglomeration and spray clogging.

The aqueous composition used in the method of the invention may contain at least one filler. When present in the composition, the filler is a means to improve the film durability, abrasion resistance, and control surface penetration. Useful fillers include Minex 4 or 7 from Unimin Corp, Calcined clay, Hydrated alumina SB-432, or calcium carbonate from J. M. Huber corp, Satintone W from Engelhard Corp. Examples of preferred fillers include Minex 4 or 7 from Unimin Corp. The filler may be present in the antifouling composition in a range of from about 2.0 percent by weight to about 40.0 percent by weight, preferably from about 5.0 percent by weight to about 20.0 percent by weight based on the total weight of the antifouling composition. Filler content greater than about 40.0 percent by weight may be less desirable in that there would be a loss in film strength and durability. Alternatively, filler content less than about 2.0 percent by weight may be less desirable in that it would be insufficient for improving the abrasion resistance and controlling surface penetration.

The aqueous composition used in the method of the invention may contain at least one pigment. When present in the composition, the pigment is a means to provide color and UV protection for the binder and antimicrobials used in the product. Useful pigments include CR-828 from Kerr-McGee Pigments, YO-313 or Y25LOM yellow iron oxide from Revelli Chemical, Hitox from the Hitox Corp., R-902 from Dupont Chemical. Examples of preferred pigments include CR-828 from Kerr-McGee and R-902 from Dupont Chemical. The pigment may be present in the antifouling composition in a range of from about 2.0 percent by weight to about 40.0 percent by weight, preferably from about 4.0 percent by weight to about 20.0 percent by weight based on the total weight of the antifouling composition. Pigment content greater than about 40.0 percent by weight may be less desirable in that it would made the product too viscous to spray, and too costly for the customer. Alternatively, pigment content less than about 2.0 percent by weight may be less desirable in that the product would have insufficient UV protection and poor coloration.

The aqueous composition used in the method of the invention may contain at least one ultra violet (UV) absorber. Useful UV absorbers include Tinuvin 192, 1130, and 5151 from Ciba Specialty Chemical, Dabco UVCW-30 from Elementis Specialties, and Zinc Oxide grades Kadox 911, 901, and XX503R from Zinc Corporation of America. Examples of preferred UV absorbers include Tituvin 5151 and Kadox 911. The UV absorber may be present in the antifouling composition in a range of from about 0.10 percent by weight to about 5.0 percent by weight, preferably from about 0.50 percent by weight to about 1.0 percent for the UV absorber and 4.0% for zinc oxide by weight based on the total weight of the antifouling composition. UV absorber content greater than about 5.0 percent by weight may be less desirable in that cost becomes too high and there would be diminishing value in further UV protection. Alternatively, UV absorber content less than about 0.10 percent by weight may be less desirable in that there would be insufficient UV protection.

The aqueous composition used in the method of the invention may contain at least one adhesion promoter. Useful adhesion promoters include Silquest A 1637, A-1120, A-189 and A-187 from GE Silicones, and Z-6020 or Z-6040 from Dow Corning. Examples of preferred adhesion promoters include Silquest A 1637 and A-1120 from GE Silicones. The adhesion promoter may be present in the antifouling composition in a range of from about 0.05 percent by weight to about 2.0 percent by weight, preferably from about 0.20 percent by weight to about 1.0 percent by weight based on the total weight of the antifouling composition. Adhesion promoter content greater than about 2.0 percent by weight may be less desirable in that it would be more than needed for a mono-molecular layer on the substrate, and the cost would be very high. Alternatively, adhesion promoter content less than about 0.05 percent by weight may be less desirable in that it would be insufficient for improving substrate adhesion.

The aqueous composition used in the method of the invention may contain at least one freeze/thaw stabilizer. Useful freeze/thaw stabilizers include ethylene glycol, propylene glycol and ethanol solvent from Ashland Chemical. Examples of preferred freeze/thaw stabilizers include propylene glycol or ethylene glycol from Ashland Chemical. The freeze/thaw stabilizer may be present in the antifouling composition in a range of from about 0.50 percent by weight to about 4.0 percent by weight, preferably from about 1.0 percent by weight to about 3.0 percent by weight based on the total weight of the antifouling composition. Freeze/thaw stabilizer content greater than about 4.0 percent by weight may be less desirable in that it would make the coating too water sensitive and the drying time too long. Alternatively, a freeze/thaw stabilizer content less than about 0.50 percent by weight may be less desirable in that it would insufficient to insure good freeze-thaw stability.

The aqueous composition used in the method of the invention may contain at least one cosolvent. When present in the composition, the cosolvent is a means to improve film coalescence at low temperatures of below 50 F (10 C), and improve sprayability and substrate wetting. Useful cosolvents include Dowanol DPnB and PPH from Dow Chemical, Texanol from Eastman Chemical, Glycol Ether PB, EB, and DPM from Ashland Chemical. Examples of preferred cosolvents include Dowanol DPnB from Dow Chemical and Texanol from Eastman Chemical. The cosolvent may be present in the antifouling composition in a range of from about 0.20 percent by weight to about 0.40 percent by weight, preferably from about 0.40 percent by weight to about 2.0 percent by weight based on the total weight of the antifouling composition. Cosolvent content greater than about 4.0 percent by weight may be less desirable in that the cost benefit drops off, the VOC content would restrict product use, and there could be product compatibility problems. Alternatively, cosolvent content less than about 0.20 percent by weight may be less desirable in that it would be insufficient for insuring good film formation at low temperatures, and be insufficient for improving substrate wetting.

If desired, other additives may be used in the aqueous composition include wetting and dispersing agents, Theological additives, and surface additives such as those available from Byk-Chemie. Various other colorants such as red, brown or yellow iron oxide pigments from Revelli Chemical, or organic based pigments from Clariant Pigment and Additive division.

The aqueous composition used in the method of the invention has a pH in a range of from about 7 to about 10, preferably in a range of from about 7.5 to about 9.0. A pH greater than about 10 may be less desirable in that it would limit the choice of antimicrobials, as several are not stable at a pH over 10. Alternatively, a pH less than about 7.5 may be less desirable in that there would be a potential for viscosity loss on aging and corrosion of metal surfaces.

The aqueous composition used in the method of the invention has a solid content in a range of from about 25 to about 65 percent, preferably in a range of from about 30 to about 55 percent. Solids content greater than about 65 percent may be less desirable in that there would be a loss in sprayability and storage stability. Alternatively, solids content less than about 25 percent may be less desirable in that there would be a long drying time, possible phase separation or settling problems on aging, and difficulty in obtaining freeze-thaw stability.

The aqueous composition used in the method of the present invention can be formed using conventional blending and mixing techniques. Preferably, the highest weight ingredient is added first and lesser weight ingredients are added thereafter using mechanical agitation.

The method of the present invention provides dried antifouling coatings having fresh-water extractable content in a range of from about 2.0 percent to about 8.0 percent, preferably in a range of from about 2.0 percent to about 6.0 percent based upon the dry weight of the film. The water extractables are water soluble components in the product such as the surfactants, freeze-thaw stabilizers, cosolvents and dispersants. Decreased water extractable content is an indication of coating hydrophobicity. A water extractable content greater than about 8.0 percent may be less desirable in that there likely would be blistering of the dried applied film soon after being immersed in fresh-water with a resultant loss of film integrity and abrasion off the substrate.

The method of the present invention provides dried antifouling coatings having a Falling Sand Abrasion less than about 0.40 grams loss per 100 pounds of sand, preferably less than about 0.20 grams loss per 100 pounds of sand. A falling sand abrasion greater than 0.40 grams loss per 100 pounds of sand may be less desirable in that there would be a shortened life expectancy in flowing fresh-water applications where surface abrasion would be expected.

The substrates used in the method of the invention are those often used as retaining structures for fresh-water including concrete, various types of cement, wood, steel, plastic, granite, aluminum, painted substrates and compacted earth. If the surface being coated is contaminated with growth it is often desirable to clean the surface prior to the application of the aqueous composition. Conventional surface cleaning techniques can be used including brushing, sweeping, or power washing with water, although the method of the present invention can be utilized effectively on growth contaminated surfaces.

The aqueous composition used in the method of the invention can be applied using conventional application techniques including brushing, rolling, and spraying to form a wet-coated substrate. If desired, the substrate can be coated prior to the manufacture of the fresh-water retaining structure. Preferably, the aqueous composition is applied to the walls and bottom of the surfaces while the canal, pool or other types of fresh-water retaining structures that have been drained. The aqueous composition is applied onto the surface in a range of from about 80 ft2/gallon to about 800 ft2/gallon, preferably from about 200 ft2/gallon to about 400 ft2/gallon. An application quantity less than 80 ft2/gallon may be less desirable in that it would be very slow to dry and at a cost greater than other competitive systems. Alternatively, an application quantity greater than 800 ft2/gallon may be less desirable in that there would be insufficient film thickness for long term abrasion resistance, hid of surface discolorations and insufficient antimicrobial content on a square foot of surface basis for complete algae and other aqueous plant growth. The wet-coated substrate formed in the method of the present invention may be dried using conventional techniques including ambient environmental drying, forced air drying, and forced air/heat drying.

### Test Methods

### Fresh-Water Extractable Content

Procedure: A film of the product is drawn down on three 11 mil aluminum panels at the recommended coverage rate, and allowed to dry at ambient conditions for a minimum of 7 days. The tare weight of the panel is taken prior to application of the coating, and the coating weight determined after drying for 7 days by re-weighing the dried coated panel. The panels are then immersed in fresh-water held at 52 C (125 F) for 24 hours. On removal from the fresh-water the panels are gently wiped dry, and allowed to dry for 7 days before taking a weight. The leached percentage is calculated by dividing the loss weight by the initial dried weight and multiplying by 100. The leached weight loss is compared to the total percentage of fresh-water soluble components in the dried coating composition to determine the weight loss of the antimicrobials plus other components by the difference between the weight loss and the known weight of fresh-water soluble components.

### Theoretical Fresh-Water Extractable Content

The theoretical water extractable content is based upon the total weight of water soluble components in the coating composition divided by the total theoretical solids content. The total theoretical solids content is the total or all non-volatile components (at ambient conditions) divided by the total weight of the composition. Water soluble components can include surfactants, dispersants, freeze-thaw stabilizers, cosolvents, and thickeners.

### Abrasion Resistance

### Method: Falling Sand, Modified ASTM D 968

Procedure: A film of the product is drawn down on an 11 mil aluminum panel at the recommended coverage rate, and allowed to dry at ambient conditions for a minimum of 7 days. The testing equipment is a 4 foot long pipe of ⅞ inch inside diameter mounted vertically with a funnel on top, and a wooden mounting block for the test panel mounted directly under the tube at 1½ inches from the outlet. The mounting block is at 45 degrees to the tube so that the falling sand impacts the coating at 45 degrees, and runs off into a collection container. The sand is poured into the funnel on the top and allowed to free fall down onto the coating. The sand falls at approximately 30 lbs/minute The panel is weighted prior to and after the testing of 100 pounds of sand. Three tests are run and an average weight loss reported. The sand to be used is an all purpose dry sand (Quikrite brand used) meeting ASTM C 33.

### Solids Content

### ASTM D 2832, Method A

### Viscosity

### ASTM D-2196: Using a Brookfield Viscometer, Model RVT, using spindle #3 or #4 at 20 RPM.

pH

### ASTM E 70, Standard Test Method for pH of Aqueous Solutions With the Glass Electrode.

### Weight per Gallon

### ASTM D 1475

### Algae Defacement

### ASTM D-5589: Standard Test Method for Determining the Resistance of Paint Films and Related Coatings to Algal Defacement.

### EXAMPLES

### Example 1

Example 1 describes an aqueous composition that is part of the method of the present invention.

| | |
|---|---|
| Water | 42.90 |
| Kelzan S, thickener | 0.05 |
| Cellosize QP-100MH, thickener | 0.20 |
| DFC-17, defoamer | 0.30 |
| PSA 336, surfactant | 0.30 |
| BYK-156, dispersant | 0.30 |
| Minex 4, mineral filler | 8.00 |
| CR-828, white pigment | 6.00 |
| Zinc Oxide, UV absorber | 2.00 |
| Sodium Omadine (40%), fungicide | 1.00 |
| Silane 1637, adhesion promoter | 0.25 |
| Propylene Glycol, freeze-thaw | 2.00 |
| Dowanol DPnB, cosolvent | 1.00 |
| Irgarol 1071, algaecide | 0.10 |
| Rocima 63 (30%), algaecide | 2.80 |
| and fungicide | |
| BASF ND 4606 SBR (50%), binder | 32.00 |
| Texanol, coalescent | .80 |
| Total- | 100.00 |

The aqueous composition has a viscosity of 1,250 centipoise, a pH of 8, a solids content of 37 percent, a weight per gallon of 9.6 pounds. The dried aqueous composition had abrasion resistance of less than 0.10 grams loss per at 3 mil thickness and an extractable content of 4.0 percent wherein the theoretical extractable content was 6.6 percent.

### Example 2

Example 2 describes an aqueous composition that is part of the method of the present invention.

| | |
|---|---|
| Water | 26.35 |
| Cellosize QP-100MH, thickener | 0.15 |
| DFC-17, defoamer | 0.20 |
| Triton X-100, surfactant | 0.30 |
| Ucar 820, Acrylic (45%) | 55.00 |
| Texanol, coalescent | 1.30 |
| CW-30, TiO2 (30%) | 1.10 |
| BYK-156, dispersant | 0.30 |
| Minex 4 or 7, mineral filler | 9.00 |
| Dowanol DPnB, cosolvent | 1.30 |
| DC 85, hydrophobe | 0.50 |
| Rocima 63 (30%), algaecide | 2.50 |
| and fungicide | |
| Rozone 2000 (20%), fungicide | 0.30 |
| and algaecide | |
| B-350 BCM (42%), fungicide | 0.50 |
| Tinuvin 5151, UV absorber | 0.60 |
| Rheolate 244, thickener | 0.40 |
| Total | 100.00 |

The aqueous composition has a viscosity of 2600 centipoise, a pH of 8, a solids content of 39 percent, a weight per gallon of 9.1 pounds. The dried antifouling coating had abrasion resistance of less than 0.10 grams loss and an extractable content of 3.2 percent wherein the theoretical extractable content was 6.4 percent.

### Example 3

Example 3 describes an aqueous composition that is part of the method of the present invention.

| | |
|---|---|
| Water | 42.40 |
| Kelzan S, thickener | 0.05 |
| Cellosize QP-100MH, thickener | 0.20 |
| DFC-17, defoamer | 0.30 |
| PSA 336, surfactant | 0.30 |
| BYK-156, dispersant | 0.30 |
| Minex 4, mineral filler | 8.00 |
| CR-828, white pigment | 6.00 |
| Zinc Oxide, UV absorber | 2.00 |
| Silane 1637, adhesion promoter | 0.25 |
| Propylene Glycol, freeze-thaw | 2.00 |
| Dowanol DPnB, cosolvent | 1.00 |
| Irgarol 1071(100%), algaecide | 0.10 |
| Rocima 63 (30%), algaecide | 2.80 |
| and fungicide | |
| Nuocide 404D (40.4%), fungicide | 1.50 |
| and algaecide | |
| BASF ND 4606 SBR (50%), binder | 32.00 |
| Texanol, coalescent | 0.80 |
| Total- | 100.00 |

The aqueous composition had a viscosity of 1200 centipoise, a pH of 9, a solids content of 38 percent, a weight per gallon of 9.6 pounds, abrasion resistance less than 0.10 grams loss and an extractable content of 5.7 percent wherein the theoretical extractable content is 6.5 percent.

### Example 4

Example 4 describes an aqueous composition that is not part of the method of the present invention.

| | |
|---|---|
| Water | 48.31 |
| Kelzan S, thickener | .05 |
| Cellosize QP-100MH, thickener | .25 |
| Triton X-100, surfactant | .30 |
| Surfynol 104H, surfactant | .10 |
| BYK-156, dispersant | .30 |
| DFC-17, defoamer | .20 |
| Kadox 911, UV absorber | .50 |
| Minex 7, mineral filler | 11.00 |
| UVCW-30 (30%), UV absorber | 1.00 |
| Ucar 145 latex (48%), binder | 36.50 |
| Texanol, coalesant | .80 |
| Fungitrol 820 (20%), fungicide | .45 |
| Amical Flowable (40%), fungicide | .24 |
| and algaecide | |
| Total | 100.00 |

The aqueous composition had a viscosity of 1200 centipoise, a pH of 9, a solids content of 33 percent, a weight per gallon of 9.2 pounds, abrasion resistance less than 0.10 grams loss and an extractable content of 5.1 percent wherein the theoretical extractable content was 6.1 percent.

### Example 5

Example 5 describes the method of the present invention using the aqueous composition described in Examples 1 & 2.

The antifouling compositions described in example 1 & 2 were applied by brush onto concrete at 400 ft2/gallon and pine wood at 600 ft2/gallon to provide wet-coated substrates. The wet-coated substrates were then allowed to dry at ambient conditions to provide dry-coated substrates. The dry-coated substrates were then submerged in fresh-water (i.e., a creek with water flowing continuously) and visually inspected for algae or other plant growth after 130-days. The results are as follows:

| Substrate | Antifouling Composition | Observation |
|---|---|---|
| Concrete | Example 1 | No growth |
| Concrete | Example 2 | No growth |
| Concrete | Example 4 | growth |
| Wood | Example 1 | No growth |
| Wood | Example 2 | No growth |
| Wood | Example 4 | growth |
| Concrete | Control (No coating) | Continuous growth |
| Wood | Control | Continuous growth |

The results indicate that the aqueous compositions described in examples 1 & 2 can be applied onto surfaces at less than about 600 ft2/gallon and effectively inhibit growth, showing the utility of the invention.

### Example 6

In Example 6, the antifouling compositions of the present invention were submitted to an independent testing lab (Rohm & Haas, Springhouse, PA) for evaluating resistance of the dried antifouling coating to algae growth on the surfaces of irrigation canals in the State of Washington.

Samples of the problem algae (i.e., Fontenalis spp. and Cladophora spp) were taken from a canal surface in the State of Washington for use in the algae resistance tests The antifouling composition described in Example 1 & Example 3 were coated onto grout tile disks (2^{1/4} inch diameter by ⅛ inch width) at 300 ft2/gallon coverage rate and dried.

The dried antifouling coated grout tile disks were then placed on Bolds Basal Agar plates and the test was conducted based on ASTM D-5589 Standard Test Method for Determining the Resistance of Paint Films and Related Coatings to Algal Defacement. The discs were inoculated with standard mixture of green algae Chlorella spp. and Chlorococcum spp.

In addition, for the wet samples a different customized method was used for this application. The coating was coated on all five walls of a plastic box and allowed to dry before filling with fresh-water and inoculating with the native algae that are known to cause problem in irrigation canals, Cladophora and Fontenalis (provided by the customer). The boxes were checked for inhibition every four weeks. A new supply of fresh-water was added to the boxes every two days to replenish the water for the growth of the algae.

### RESULTS

| Sample ID | 1 week | 2 week | 3 week | 4 week |
|---|---|---|---|---|
| Agar Plate Method | | | | |
| Blank | 3 | 3 | 4 | 4 |
| Example 1 | 0 | 0 | 0 | 0 |
| Example 3 | 0 | 0 | 0 | 0 |
| Plastic Box Method* | | | | |
| Blank | Growth | Growth | Growth | Growth |
| Example 1 | Inhibited | Inhibited | Inhibited | Inhibited |

*Growth in Plastic Box Method as qualitative assessment, Growth Meaning the algae revived and shows signs of growth, ‘Inhibited’ means the inoculum's did not grow and died off.

I claim:

1. A method comprising the steps of:
A. providing at least one aqueous composition comprising;
i. at least one aqueous polymer;
ii. at least one algaecide;
iii. at least one fungicide;
iv. at least one surfactant
v. at least one ultra-violet blocking component
B. providing at least one retaining structure for fresh-water;
C. applying said composition onto said structure to form a wet-coated substrate; and
D. drying the wet-coated substrate to form a dried antifouling coating.

2. The method as described in claim 1, wherein said polymer is selected from the group consisting of aqueous polyacrylics, aqueous polystyrene-acrylics, aqueous polystyrene-butadiene rubbers, and aqueous polychlorinated-ethylene-acetate copolymers.

3. The method as described in claim 1, wherein said algaecide is selected from the group consisting of Amical Flowable, Sodium or Zinc Omadine, Mergal S-90 or 89, Polyphase 588, Irgarol 1071, Irgarol 1075, Nuocide 404D, and Rocima 63 or 65.

4. The method as described in claim 1, wherein said fungicide is selected from the group consisting of Diuron, Sodium or Zinc Omadine, Polyphase AF-1 or 588, Metasol TK-50 A.D., Nuocide 404D or 960, Rocima 63 or 65, Rozone 2000, and B-350 BCM.

5. The method as described in claim 1, wherein said composition further comprises at least one additive selected from the group consisting of dispersant, defoamer, wetting agent, surface additive, adhesion promoter, pigment, filler, and freeze-thaw stabilizer.

6. The method as described in claim 1, wherein said composition has a pH in a range of from about 7.5 to about 10.0.

7. The method as described in claim 1, wherein said composition has a viscosity in a range of from about 500 centipoise to about 10,000 centipoise.

8. The method as described in claim 1, wherein said composition has solids content in a range of from about 25 percent to about 65 percent.

9. The method as described in claim 1, wherein said composition has a weight per gallon in a range of from about 8.0 pounds per gallon to about 12.5 pounds per gallon.

10. The method as described in claim 1, wherein said substrate is selected from the group consisting of concrete, wood, steel, plastic, granite, aluminum, compacted earth, and paint.

11. The method as described in claim 1, wherein said composition is applied on said structure in a range of from about 80 square feet per gallon to about 800 square feet per gallon.

12. The method as described in claim 1, wherein said coating has an extractable content less than 8.0 percent.

13. The method as described in claim 1, wherein said coating has abrasion resistance of less than about 0.40 grams loss.

14. The method as described in claim 1, wherein said coating has fresh-water extractable content less than about 6 percent.

15. The method as described in claim 1, wherein said coating inhibits green algae growth thereon for greater than 50-days when submersed in fresh-water and subjected to a mixture of green algae selected from the group consisting of chlorella and chlorococcum.

16. The method as described in claim 1, wherein said coating inhibits algae growth thereon for greater than 50-days when submersed in fresh-water and subjected to a mixture of algae selected from the group consisting of fontenalis and cladophora.

17. The method as described in claim 1, wherein said coating is applied into an irrigation canal.

18. The method as described in claim 1, wherein said coating inhibits algae growth thereon for greater than 130-days when submersed in fresh-water and subjected to ambient environmental conditions.

19. The method as described in claim 1, wherein said coating passes ASTM D-5589.
